(19) United States
(12) Patent Application Publication
(10) Pub. No.: US 2015/0028779 A1
(43) Pub. Date: Jan. 29, 2015

(54) ELECTRIC MACHINE

(71) Applicant: GE Energy Power Conversion Technology Ltd, Warwickshire (GB)

(72) Inventor: Stephane Mouty, Oron (FR)

(21) Appl. No.: 14/374,194

(22) PCT Filed: Jan. 23, 2013
(86) PCT No.: PCT/EP2013/051261

§ 371 Date: Jul. 23, 2014

(30) Foreign Application Priority Data
Jan. 24, 2012 (FR) 1250678

(51) Int. Cl. H02P 25/10

(52) U.S. Cl. CPC H02P 25/107
USPC 318/244

(57) ABSTRACT

An electric machine, including a set of at least six windings, voltage supply devices capable of supplying an electrical phase, and a circuit for controlling the voltage supply devices controlling phase shifts between the phases supplied by the voltage supply devices, each voltage supply device supplying a phase at the end common to two windings, the other end of the two windings being supplied by one of the two voltage supply devices supplying a phase of which the phase shift with the phase supplied by the voltage supply device is one of the two lowest, in terms of absolute value, among the phase shifts supplied by the voltage supply devices and the phase supplied by the voltage supply device.

### BACKGROUND OF THE INVENTION

Embodiments of the present invention relate to an electrical machine.

An electrical machine is an electro-mechanical device permitting the conversion of electrical energy into work or into mechanical energy. Alternating current electrical machines consist of a stator and a rotor. The stator consisting of windings generates a rotating field to which the rotor is subjected. The rotor is made either from permanent magnets or from windings. Thanks to this device, the flux of the rotor and the stator can be offset in an optimal manner (in quadrature). This offset creates a torque according to the law of maximum flux (a north pole attracting a south pole), thus leading to the rotation of the rotor.

Therefore, it is desirable to create electrical machines that function in an optimal manner.

It is known from the thesis of Yvan Crévits entitled Characterisation and command of multi-phase engines in reduced power supply mode (thesis of the University of Sciences and technologies in Lille, submitted on July 12, 2010) that an electrical machine can be six-phased with the six phases distributed in two independent stars. The phases of the two stars are usually shifted at π/6. The multi-phase machine resulting from this association is shown schematically in FIG. 2 which is described below.

The multi-phase machine resulting from this association helps to take advantage of the experience obtained in the implementation of three-phase windings. The windings of these machines can be powered independently by full-wave inverters by distributing the currents between the phase groups in such a way to avoid the effects of the mutual induction.

The windings can also be powered by other components. The evolution of the components of power electronics has actually enabled the use of components with high-frequency commutation. These components permit to limit the harmonics in the power supply signals and to control the phase difference between the current and the voltage of the systems. The voltage inverters are one example. The use of voltage inverters permits to achieve low harmonic distortion rates of the power supply, which results in low content of harmonics in the currents. The low content of harmonics permits to limit the losses in the different parts of the machine independently of the losses from the induced current or the losses in the conductors.

The “reduced power supply mode” or the “reduced mode” appears when the integrity of the electrical power supply is doubtful due to problems in the source, the electrical connection to the machine or to an internal defect of the machine. Such a multi-phase machine appears interesting in the use of the reduced mode due to the significant number of independent phases. In effect, the significant number of the phases provides a favourable redundancy to the functioning in reduced mode.

But if during the functioning in reduced mode one branch of the star is damaged, the corresponding phase is not used anymore. Also, if the power supply device is damaged, the corresponding winding does not function anymore. In both cases, this results in energy loss.

Therefore, there is a need for an electrical machine that helps to achieve better performance in reduced mode, namely in the case of the loss of one phase or damage to one branch of the inverter.

### BRIEF SUMMARY OF THE INVENTION

For this purpose, an embodiment of the present invention proposes an electrical machine comprising: a set of at least six windings, each comprising two ends, with the windings in a series configuration, voltage supply devices capable of supplying an electrical phase, a control circuit of the voltage supply devices controlling the phase differences between the phases supplied by the power supply devices, each voltage supply device powers one phase with a common end of two windings, with the other end of the two windings powered by one of the two voltage supply devices, which powers one phase, whose phase shift with the phase powered by the voltage supply device is one of the two that are the lowest in absolute value among the phase shifts between the phases powered by the voltage supply devices and the phase powered by the voltage supply device.

According to other embodiments of the present invention, taken separately or in combination: the voltage supply devices are distributed in an arrangement of at least three voltage supply devices; the control circuit comprises of one control unit per arrangement; every control unit is adapted to apply one control law to the voltage supply devices of the arrangement managed by the control unit; the control law is such that the phase shift between the phase powered by a voltage supply device of an arrangement and the phase powered by the voltage supply device having the phase shift that is the closest in the same arrangement is equal to 2π/n, where n is the number of the voltage supply devices of the arrangement; each of the arrangements comprise of an odd number of voltage supply devices; the arrangements comprise of the same number of voltage supply devices; the electrical machine comprises of two arrangements: a first arrangement of at least three voltage supply devices, of which a first voltage supply device of reference powers a first electrical phase of reference, and a second arrangement of at least three voltage supply devices, of which a second voltage supply device of reference powers a second electrical phase of reference, with the reference phase shift between the first and the second electrical phase being different from 0; the reference phase shift is equal to 7E; the machine comprises of, in addition, a stator, with every voltage supply device located in the stator; the voltage supply devices are positioned in the stator in the form of a regular polygon, the voltage supply devices are positioned in the stator in the form of a hexagon, the voltage supply devices are adapted to deliver a sinusoidal electric signal with harmonic distortion rate less than or equal to 5%.

### BRIEF DESCRIPTION OF THE DRAWINGS

Other characteristics and advantages of the invention will appear after reading the detailed description, which follows from the modes of embodiment of the invention, provided as an example only, and in reference to the drawings which show:

FIG. 1, a diagrammatic view of an example of the machine according to an embodiment of the present invention; and

FIG. 2, a diagrammatic view of an example of the machine according to the state of the art.

### DETAILED DESCRIPTION

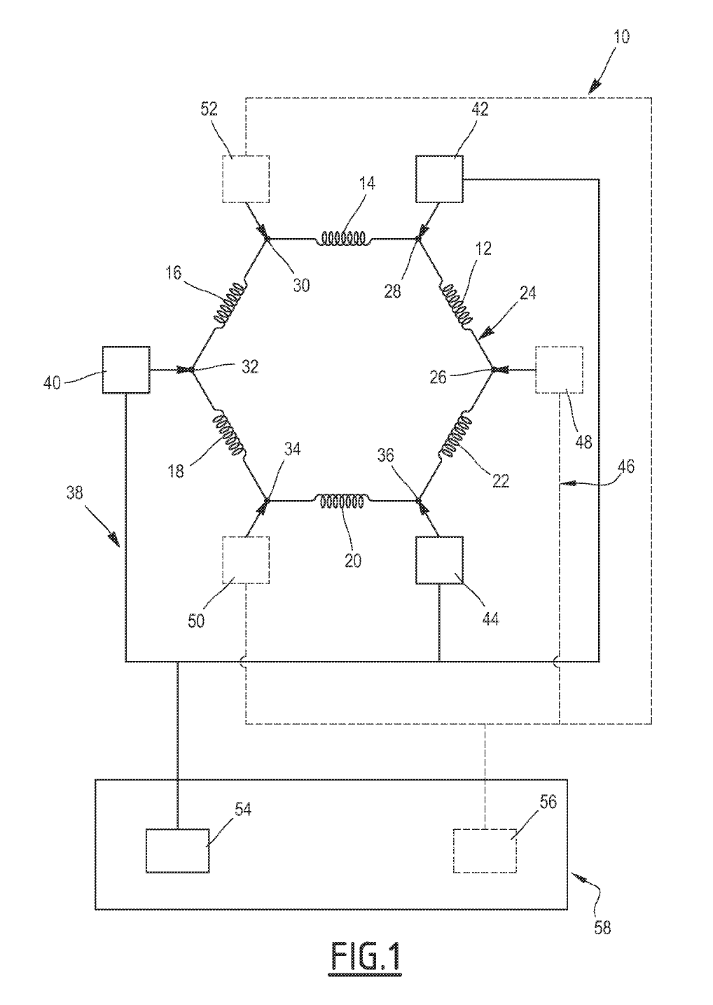

An electrical machine 10, such as the one presented in FIG. 1, is proposed. For convenience only, the diagram in FIG. 1 shows only part of the machine 10, knowing that the machine 10 comprises a stator and a rotor.

The stator comprises of six windings 12, 14, 16, 18, 20 and 22 forming a set 24. The number of the windings 12, 14, 16, 18, 20 and 22 can be more. Each winding 12, 14, 16, 18, 20 and 22 comprises of two ends. Moreover, the windings 12, 14, 16, 18, 20 and 22 are in a series configuration. This means that each winding is connected on both sides to another winding. Thus the winding set 24 forms a closed loop.

In the example in FIG. 1, if the loop is crossed in the trigonometric direction, the alternation of the windings is as follows: winding 12—winding 14—winding 16—winding 18—winding 20—winding 22 then return to winding 12. In terms of the ends, this means that the end 26 is common to windings 12 and 22; the end 28 to windings 12 and 14; the end 30 to windings 14 and 16; the end 32 to windings 16 and 18; the end 34 to windings 18 and 20 and the end 36 to windings 20 and 22.

In addition, the electrical machine 10 comprises voltage supply devices capable to power the phases to the windings 12, 14, 16, 18, 20 and 22, with the voltage supply devices connected to one end of one winding 12, 14, 16, 18, 20 and 22.

The machine 10 comprises thus a first arrangement 38 of at least three voltage supply devices capable to power one electrical phase. According to the example in FIG. 1, only three voltage supply devices 40, 42 and 44 are shown, with the understanding that there can be any number of voltage supply devices in the first arrangement 38.

In particular, the number of the voltage supply devices in the first arrangement 38 is an odd number. The choice of an odd number of phases for an arrangement contributes to limiting the generated harmonics spatially. This results in a reduction of the amplitude of the oscillations of the torque of the rotor of the machine 10.

The voltage supply devices 40, 42 and 44 are represented diagrammatically by rectangles in a solid line. In particular, they can be voltage inverters.

The voltage supply device 40 is a first voltage supply device of reference powering a first electric phase of reference. The phase powered by the voltage supply device 40 is marked by V₁₁ further on. The phases, which are capable to power the voltage supply devices 42 and 44, are marked by V₁₂ and V₁₃.

The machine 10 also comprises of a second arrangement 46 of at least three voltage supply devices capable of powering one electrical phase. The first arrangement 38 and the second arrangement 46 are not confused. According to the example in FIG. 1, only three voltage supply devices 48, 50 and 52 are shown, with the understanding that there can be any number of voltage supply devices in the second arrangement 46.

In particular, due to the same grounds as before, the number of the voltage supply devices in the second arrangement 46 is an odd number. In addition, it is independent of the number of the voltage supply devices in the first arrangement 38. Nonetheless, the same number of voltage supply devices in the first and second arrangements 38 and 46 help to obtain an assembly that is easier to implement.

In addition, the voltage supply devices 48, 50 and 52 are represented diagrammatically in FIG. 1 by dotted line rectangles. In particular, they can be voltage inverters.

The voltage supply device 48 is a second voltage supply device of reference powering a second electric phase of reference. The phase powered by the voltage supply device 48 is marked by V₂₁ further on. The phase shift of reference between the first and the second electric phase of reference is different from 0. By marking with Δφ_{REF} the phase shift of reference and with φ(V) the function, which associates the phase with a given voltage V, this last relation is interpreted mathematically in the following way:

Δφ_{REF}=φ(V₂₁)−φ(V₁₁)≠0 (relation 1)

With such a relation, the signals V₁₁ and V₂₁ are different.

In a similar manner to the notations introduced for the first arrangement 38, the phases, which are capable of powering the voltage supply devices 50 and 52, are marked, respectively, by V₂₂ and V₂₃.

In the example in FIG. 1, the phase shift between the phase powered by a voltage supply device of one arrangement and the phase powered by the voltage supply device having the closest phase shift in the same arrangement is equal to 2π/3. More precisely, for the first arrangement 38, this means that three distinct relations are fulfilled, with the understanding that if two of the relations are fulfilled, the third one is also fulfilled:

$$\{ \begin{matrix}{Δϕ}_{1} = ϕ ( {V}_{12} ) - ϕ ( {V}_{11} ) = \frac{2 Π}{3} & ( relation 2 ) \\ {Δϕ}_{2} = ϕ ( {V}_{13} ) - ϕ ( {V}_{12} ) = \frac{2 Π}{3} & ( relation 3 ) \\ {Δϕ}_{3} = ϕ ( {V}_{11} ) - ϕ ( {V}_{13} ) = \frac{2 Π}{3} & ( relation 4 )\end{matrix}$$

where:
φ(V) the function which is associated to the phase of a given voltage V;
Δφ₁ is the phase shift between the phase V₁₁ and the phase V₁₂;
Δφ₂ is the phase shift between the phase V₁₂ and the phase V₁₃;
Δφ₃ is the phase shift between the phase V₁₃ and the phase V₁₁;

A system of similar relations can be written for the second arrangement 46 in the case when the phase shift between the phase powered by voltage supply device of an arrangement and the phase powered by the voltage supply device having the phase shift that is the closest in the same arrangement, is equal to 2π/3:

$$\{ \begin{matrix}{Δϕ}_{4} = ϕ ( {V}_{23} ) - ϕ ( {V}_{22} ) = \frac{2 Π}{3} & ( relation 5 ) \\ {Δϕ}_{5} = ϕ ( {V}_{21} ) - ϕ ( {V}_{23} ) = \frac{2 Π}{3} & ( relation 6 ) \\ {Δϕ}_{6} = ϕ ( {V}_{22} ) - ϕ ( {V}_{21} ) = \frac{2 Π}{3} & ( relation 7 )\end{matrix}$$

where:
φ(V) the function which is associated to the phase of a given voltage V;
Δφ₄ is the phase shift between the phase V₂₃ and the phase V₂₂;
Δφ₅ is the phase shift between the phase V₂₁ and the phase V₂₃;
Δφ₃ is the phase shift between the phase V₂₂ and the phase V₂₁.

The maintaining of the phase shifts Δφ₁, Δφ₂, Δφ₃, Δφ₄, Δφ₅ and Δφ₆ equal to 2π/3 helps to obtain phases in congruence, which helps to obtain the largest possible effective signal in terms of amplitude.

In the case when an arrangement comprises of n voltage supply devices, in order to obtain the largest possible effective signal in terms of amplitude, it is desirable that the phase shift between the phase powered by a voltage supply device of an arrangement and the phase powered by the voltage supply device having the phase shift that is the closest in the same arrangement is equal to 2π/n. This is interpreted mathematically by the following set of relations:

$$\{ \begin{matrix}{Δϕ}_{1}^{′} = ϕ ( {V}_{12} ) - ϕ ( {V}_{11} ) = \frac{2 Π}{n} & ( relation 8 ) \\ ( … ) & \\ {Δϕ}_{n}^{′} = ϕ ( {V}_{11} ) - ϕ ( {V}_{1 n} ) = \frac{2 Π}{n} & ( relation 9 )\end{matrix}$$

where:
φ(V) the function which is associated to the phase of a given voltage V;
Δφ′ᵢ is the phase shift between the phase V₁ᵢ₊₁ and the phase V₁ᵢ;

According to the example in FIG. 1, such relations (relations 2, 3, 4, 5, 6 and 7) are obtained with the help of control units which impose a control law to the voltage supply devices of the arrangements. More precisely, a first control unit 54 imposes a first control law to the voltage supply devices of the first arrangement 38 while a second control unit 56 imposes a second control law to the voltage supply devices of the second arrangement 46. The first control law makes sure that the relations 2, 3 and 4 are verified by the phases V₁₁, V₁₂ and V₁₃. The second control law requires that the phases V₂₁, V₂₂ and V₂₃ verify the relations 5, 6 and 7.

These two units 54 and 64 are part of a control circuit 58 of voltage supply devices. This control circuit 58 controls the phase shifts between the phases powered by the voltage supply devices. Such control permits to obtain an effective signal of large amplitude.

In addition, each voltage supply device of the two arrangements is connected to the two voltage supply devices, for which the phase shift between the phases powered by the voltage supply devices and the phase powered by the voltage supply device is the least in absolute value, via a winding. In other words, a voltage supply device that is to be connected is linked on the one hand to a first voltage supply device via one winding and, on the other hand, to a second voltage supply device via a second winding. The first voltage supply device powers one phase, whose phase shift with the phase of the voltage supply device to be connected is the lowest, while the second voltage supply device powers one phase, whose phase shift with the phase of the voltage supply device to be connected is the lowest, except for the phase shift between the first voltage supply device and the voltage supply device to be connected.

In the particular case in FIG. 1, each voltage supply device of an arrangement is thus connected to two voltage supply devices of the other arrangement. More precisely, the voltage supply device 40 is connected, on the one hand, to the voltage supply device 52 via a winding 16 and, on the other hand, to the voltage supply device 50 via a winding 18. The voltage supply device 42 is connected, on the one hand, to the voltage supply device 52 via a winding 14 and, on the other hand, to the voltage supply device 46 via a winding 12. Finally, the voltage supply device 44 is connected, on the one hand, to the voltage supply device 46 via a winding 22 and, on the other hand, to the voltage supply device 50 via a winding 20.

From the point of view of the voltage supply devices of the second arrangement 46, this is expressed by the following connections: The voltage supply device 48 is connected, on the one hand, to the voltage supply device 42 via the winding 12 and, on the other hand, to the voltage supply device 44 via the winding 22; the voltage supply device 50 is connected, on the one hand, to the voltage supply device 40 via the winding 18 and, on the other hand, to the voltage supply device 44 via the winding 20 and the voltage supply device 52 is connected, on the one hand, to the voltage supply device 40 via the winding 16 and, on the other hand, to the voltage supply device 42 via the winding 14.

In the case when there are more than two voltage supply devices, for which the phase shift between the phases powered by the voltage supply devices and the phase powered by the voltage supply device is the lowest, one advantageous way to select the voltage supply devices, to which the voltage supply device under consideration is connected, is to also take into account the ease of the connection. As an example, a connection with the two voltage supply devices, which are the closest in terms of distance, may be considered.

The preceding description is a description of the machine 10 from the point of view of the voltage supply devices. It is possible to describe the machine 10 also from the point of view of the windings.

According to this point of view, each voltage supply device 40, 42, 44, 48, 50 and 52 powering a phase of a common end of two windings 12, 14, 16, 18, 20 and 22, the other end of the two windings 12, 14, 16, 18, 20 and 22 being powered by one of the two voltage supply devices 40, 42, 44, 48, 50 and 52 powering a phase, whose phase shift with the phase powered by the voltage supply device 40, 42, 44, 48, 50 and 52 is one of the two least in absolute value among the phase shifts between the phases powered by the voltage supply devices and the phase powered by the voltage supply device 40, 42, 44, 48, 50 and 52.

Therefore, the end 26 is powered by the voltage supply device 46; the end 28 by the voltage supply device 42; the end 30 by the voltage supply device 52; the end 32 by the voltage supply device 40; the end 34 by the voltage supply device 50 and the end 36 by the voltage supply device 44.

This description from the point of view of the windings describes the same structure as the one from the point of view of the voltage supply devices, namely the structure in FIG. 1.

In addition, according to the example in FIG. 1, the voltage supply devices of each of the two arrangements are positioned in the stator. Their arrangement is in a regular polygon, i.e. such that the voltage supply devices are at the corners of a regular polygon. In the special case in FIG. 1, the regular polygon is a hexagon. Such a configuration facilitates the implementation of the connection.

Within the framework of normal functioning, all voltage supply devices 40, 42, 44, 48, 50 and 52 power one voltage. The voltage applied to each winding 12, 14, 16, 18, 20 and 22 of the machine is, therefore, the resultant of the voltage of the voltage supply devices. Thus, as an example, the winding 16 is subjected to voltage V₁₁-V₂₃ at its terminals. Each voltage supply device 40, 42, 44, 48, 50 and 52 shows also current in sinusoidal form whose amplitude is controlled by the control device 58.

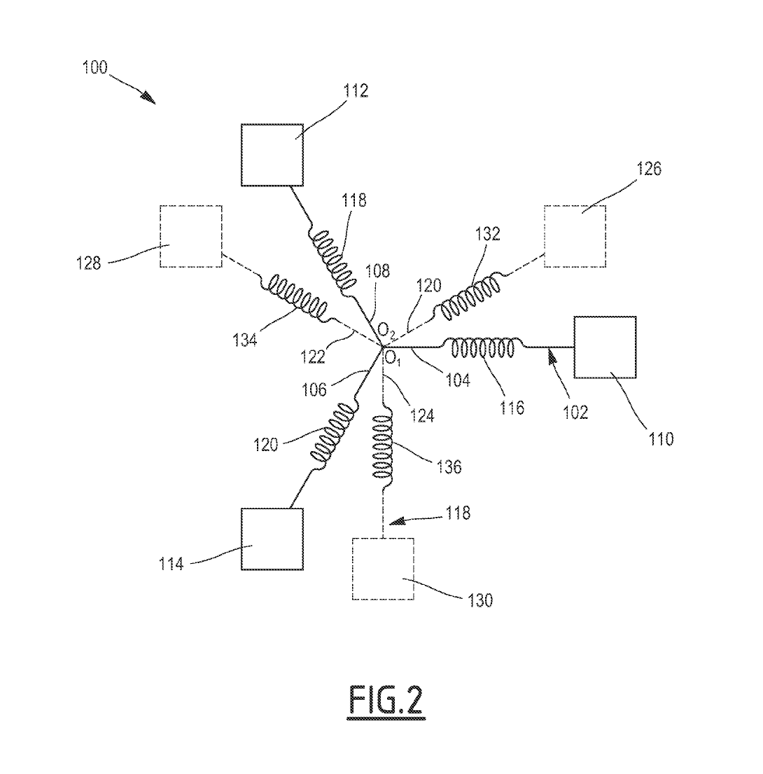

It will be demonstrated now that the machine 10 illustrated in FIG. 1 presents a better availability of power in reduced mode than a double-star machine according to the state of the art. Such a machine 100, multi-phased according to the state of the art, is shown in FIG. 2. According to the example in FIG. 2, the machine 100 comprises a first arrangement 102 of windings, comprising three branches 104, 106 and 108 connecting a first centre O₁ to the voltage supply devices 110, 112 and 114 capable of powering a phase via a winding 116, 118 and 120. In a similar manner to what was described for FIG. 1, the phase shifts between the phases of the voltage supply devices 110, 112 and 114 are 2π/3. It comprises also of a second arrangement 118 of windings comprising three branches 120, 122 and 124 connecting a first centre O₂ to the voltage supply devices 126, 128 and 130 capable of powering one phase via a winding 132, 134 136. In a similar manner to what was described for FIG. 1, the phase shifts between the phases of the voltage supply devices 126, 128 and 130 are 2π/3.

The availability of power of the two electrical machines 10 and 100 in FIGS. 1 and 2 is the same in normal mode. On the contrary, the availability of power of the machine 10 is greater than that of the machine 100 in reduced mode.

Let us suppose that one voltage supply device is damaged, the voltage supply device 42 in the case in FIG. 1 and the voltage supply device 112 in the case in FIG. 2. The machine 10 in FIG. 1 or the machine 100 in FIG. 2 functions then in reduced mode. In the case of FIG. 2, no current is circulating in the branch 108. Therefore, the winding 118 is not used. However, in the case in FIG. 1, each winding 12 and 14 connected to the damaged voltage supply device 42 is also connected to the voltage supply devices 46 and 52, which are not damaged. Therefore, the voltage applied to the windings 12 and 14 is the combination of the power supply voltages of 46 and 52. As a result, current is running through all windings of the machine 10 even in the case of failure of the voltage supply device 42. Therefore, each one of the six windings of the machine 10 continues to be used, while only five windings are used by the machine 100. Thus it appears that the power available to the machine 10 in reduced mode is greater than that of the machine capacity of the machine 100. This is valid no matter whether the machine 100 is powered by voltage or current supply devices.

In reduced mode, the machine 10 illustrated in FIG. 1 presents thus a better availability of power than a double-star machine according to the state of the art.

This effect is still more reasonable when the phase shift of reference Δφ_{REF} is equal to π.

In reduced mode, in order to limit the parasite effects (oscillation of the torque, limitation of the current . . . ), it is possible, in addition, to adapt the control of the power supply devices. This is more difficult to achieve with current supply.

The power supply of a machine 10 with current pulses is more delicate in reduced mode. In normal functioning, one of the power supply devices shows a positive current, let us suppose that here it is the power supply device 40. This current is separated in two in order to cross the windings of the machine, then another first power supply device shows a negative current. Only two of the power supply devices are used in this case. A commutation (stopping the power supply devices 40 and 48 and providing power supply with the help of the power supply devices 52 and 44, for example) is necessary to pass to the following stage of power supply.

In the case of failure of the power supply system, it is necessary also to stop using the power supply device that is associated with it. It is possible to function with the remaining power supply devices. In this case, in an embodiment, the machine has more windings in order to obtain an operating mode with limited parasitic effects (namely, oscillation of the torque). This is nonetheless difficult and leads to an increase in the cost.

Moreover, the machine 10 helps to preserve the specific features of a multi-phase machine and particularly its higher tolerance to faults than a three-phase machine.

The machine 10 also helps to obtain functioning in electric commutation.

In addition, the electrical machine 10 is beneficial such that it is easy to be obtained starting from a double-star assembly according to the state of the art. In order to pass from the assembly in FIG. 2 to the one in FIG. 1, actually it is enough to modify the branching of the windings without having to completely change the dimensions of the machine. The dimensions of the machine 10 are equivalent to the one used for a three-phase machine. Therefore, consideration of an architecture such as the one in FIG. 1 has little impact on the cost and the complexity of the manufacturing of the machine.

In an embodiment, the voltage supply devices 40, 42, 44, 48, 50, 52 are adapted to deliver a sinusoidal electrical signal with harmonic distortion rate less than or equal to 5%.

A sinusoidal electrical signal with harmonic distortion rate less than or equal to 5% is a sinusoidal signal or a quasi-sinusoidal signal. A sinusoidal signal is a signal whose harmonic distortion rate is zero.

Compared to the use of an electrical signal of the square type or of the trapezoidal type, an electrical signal with harmonic distortion rate less than or equal to 5% is advantageous insofar as the electrical machine presents better efficiency (less vibration, less heat build-up, etc.).

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A electrical machine, comprising:
a set of at least six windings, each of the at least six windings comprising two ends, the windings being in a series configuration;
voltage supply devices configured to supply electrical phases, the voltage supply devices being distributed in arrangements of at least three voltage supply devices; and
a control circuit for the voltage supply devices, the control circuit configured to control phase shifts between the electrical phases supplied by the voltage supply devices,
wherein each voltage supply device supplying a phase at an end common to two windings, another end of the two windings being supplied by one of the other voltage supply devices supplying a phase, of which the phase shift with the phase supplied by the voltage supply device is one of the two lowest, in terms of absolute value, among the phase shifts between the phases supplied by the other voltage supply devices and the phase supplied by the voltage supply device,
wherein the voltage supply devices are configured to deliver a sinusoidal electrical signal with harmonic distortion rate less than or equal to 5%,
wherein the control circuit comprises one control unit per each of the arrangements, each control unit is configured to impose a control law on the voltage supply devices of the arrangement controlled by the control unit, and
wherein the control law is such that the phase shift between the phase supplied by a voltage supply device of an arrangement and the phase supplied by a voltage supply device having the phase shift that is the closest in the same arrangement is equal to 2π/n, where n is the number of the voltage supply devices of the arrangement.

2. The machine according to claim 1, wherein each of the arrangements comprises an odd number of voltage supply devices.

3. The machine according to claim 1, wherein the arrangements comprise of the same number of voltage supply devices.

4. The electrical machine according to claim 1, comprising two arrangements comprising:
a first arrangement of at least three voltage supply devices, of which a first reference voltage supply device supplies a first reference electrical phase; and
a second arrangement of at least three voltage supply devices, of which a second reference voltage supply device supplies a second reference electrical phase, with a reference phase shift between the first and the second electrical phase being different from 0.

5. The machine according to claim 4, wherein the reference phase shift is equal to π.

6. The machine according to claim 1, further comprising a stator, with each of the voltage supply devices being located in the stator.

7. The machine according to claim 6, wherein the voltage supply devices are positioned in the stator in the form of a regular polygon.

8. The machine according to claim 6, wherein the voltage supply devices are positioned in the stator in the form of a hexagon.

9. The machine according to claim 2, wherein the arrangements comprise of the same number of voltage supply devices.

10. The electrical machine according to claim 2, comprising two arrangements comprising:
a first arrangement of at least three voltage supply devices, of which a first reference voltage supply device supplies a first reference electrical phase; and
a second arrangement of at least three voltage supply devices, of which a second reference voltage supply device supplies a second reference electrical phase, with a reference phase shift between the first and the second electrical phase being different from 0.

11. The machine according to claim 10, wherein the reference phase shift is equal to π.

12. The electrical machine according to claim 3, comprising two arrangements comprising:
a first arrangement of at least three voltage supply devices, of which a first reference voltage supply device supplies a first reference electrical phase; and
a second arrangement of at least three voltage supply devices, of which a second reference voltage supply device supplies a second reference electrical phase, with a reference phase shift between the first and the second electrical phase being different from 0.

13. The machine according to claim 12, wherein the reference phase shift is equal to π.

14. The machine according to claim 2, further comprising a stator, with each of the voltage supply devices being located in the stator.

15. The machine according to claim 3, further comprising a stator, with each of the voltage supply devices being located in the stator.

16. The machine according to claim 4, further comprising a stator, with each of the voltage supply devices being located in the stator.

17. The machine according to claim 5, further comprising a stator, with each of the voltage supply devices being located in the stator.
